(19) United States
(12) Patent Application Publication
(10) Pub. No.: US 2023/0215440 A1
(43) Pub. Date: Jul. 6, 2023

(54) SYSTEM AND METHOD FOR SPEAKER VERIFICATION

(71) Applicant: CLIPr Co., Kirkland, WA (US)

(72) Inventors: Zarrar Shehzad, New Haven, CT (US); Aaron Sloman, Costa Mesa, CA (US); Cindy Chin, New York, NY (US)

(21) Appl. No.: 17/569,495

(22) Filed: Jan. 5, 2022

(51) Int. Cl. G10L 17/06; G10L 17/18; G06N 3/04; G06N 3/08

(52) U.S. Cl. CPC G10L 17/06; G10L 17/18; G06N 3/0454; G06N 3/08

(57) ABSTRACT

A system for speaker verification is disclosed. An input receiving module receives an input audio-visual segment. An input processing module identifies one or more unlabelled speakers and one or more moments in time associated with each of the one or more unlabelled speakers in the audio-visual segment. An information extraction module extracts audio data representative of speech signal and visual data representative of facial images respectively. An input transformation module employs a first pre-trained neural network model to transform audio data of each unlabelled speaker into speaker speech space, employs a second pre-trained neural network model to transform visual data of each unlabelled speaker into speaker face space, and trains a third neural network model to match the audio data and the visual data of each unlabelled speaker with names of the labelled speakers obtained from prestored datasets. A speaker identification module identifies each unlabelled speaker with corresponding names, estimates confidence level corresponding to identification of the each unlabelled speaker from the audio-visual segment.

### FIELD OF INVENTION

Embodiments of the present disclosure relate to a speech recognition system and more particularly to a system and a method for speaker verification system.

### BACKGROUND

Characteristics of a human's voice can be used to identify the human from other humans. Voice recognition systems attempt to convert human voice to audio data that is analyzed for identifying characteristics. Similarly, the characteristics of a human's appearance can be used to identify the human from other humans. For identification of the characteristics of the humans, several speaker recognition systems and face recognition systems attempt to analyze captured audio and images for identifying visible human characteristics. Generally, the speaker recognition systems includes three aspects: speaker detection, which relates to detecting if there is a speaker in the audio, speaker identification which relates to identifying whose voice it is and speaker verification or authentication which relates to verifying someone's voice.

Conventionally, the speaker recognition systems which are available in the market recognises the speaker from audio signals or sounds obtained as input data. However, such a conventional system recognises the speaker from voiceprints or the audio signals and verifying the speaker by comparing with pre-stored voiceprints manually which is not only time consuming but also prone to one or more human errors. As used herein, the term ‘voiceprints’ is defined as individual distinctive patterns of certain voice characteristics that is spectrographically produced. Also, such a conventional system requires judgements to verify the speaker upon comparison with the pre-stored voiceprints, which further includes manual intervention.

Hence, there is a need for an improved system and a method for speaker verification in order to address the aforementioned issues.

### BRIEF DESCRIPTION

In accordance with an embodiment of a present disclosure, a system for speaker verification is disclosed. The system includes a processing subsystem hosted on a server and configured to execute on a network to control bidirectional communications among a plurality of modules. The processing subsystem includes an input receiving module configured to receive an input audio-visual segment from an external source. The processing subsystem also includes an input processing module configured to identify one or more unlabelled speakers from the input audio-visual segment received. The input processing module is also configured to identify one or more moments in time associated with each of the one or more unlabelled speakers in the audio-visual segment received using an automated speech recognition technique. The processing subsystem also includes an information extraction module configured to extract audio data representative of speech signal and visual data representative of facial images respectively from the audio-visual segment based on the one or more moments identified. The processing subsystem also includes an input transformation module configured to employ a first pre-trained neural network model to transform extracted audio data representative of speech signal of each unlabelled speaker into a speaker speech space. The input transformation module is also configured to employ a second pre-trained neural network model to transform extracted visual data representative of facial images of each unlabelled speaker into a speaker face space. The input transformation module is also configured to train a third neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively. The processing subsystem also includes a speaker identification module configured to identify the each unlabelled speaker with corresponding names based on a matching result obtained from the third neural network model. The speaker identification module is also configured to estimate a confidence level of the third neural network model corresponding to identification of the each unlabelled speaker from the audio-visual segment.

In accordance with another embodiment of the present disclosure, a method for speaker verification is disclosed. The method includes receiving, by an input receiving module of a processing subsystem, an input audio-visual segment from an external source. The method also includes identifying, by an input processing module of the processing subsystem, one or more unlabelled speakers from the input audio-visual segment received. The method also includes identifying, by the input processing module of the processing subsystem, one or more moments in time associated with each of the one or more unlabelled speakers in the audio-visual segment received using an automated speech recognition technique. The method also includes extracting, by an information extraction module of the processing subsystem, audio data representative of speech signal and visual data representative of facial images respectively from the audio-visual segment based on the one or more moments identified. The method also includes utilizing, by an input transformation module of the processing subsystem, a first pre-trained neural network model to transform extracted audio data representative of speech signal of each unlabelled speaker into a speaker speech space. The method also includes employing, by the input transformation module of the processing subsystem, a second pre-trained neural network model to transform extracted visual data representative of facial images of each unlabelled speaker into a speaker face space. The method also includes training, by the input transformation module of the processing subsystem, a third neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively. The method includes identifying, by a speaker identification module of the processing subsystem, the each unlabelled speaker with corresponding names based on a matching result obtained from the third pre-trained neural network model. The method also includes estimating, by the speaker identification module of the processing subsystem, a confidence level of the third neural network model corresponding to identification of the each unlabelled speaker from the audio-visual segment.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for speaker verification in accordance with an embodiment of the present disclosure;

FIG. 2 illustrates a schematic representation of an exemplary embodiment of a system for speaker verification of FIG. 1 in accordance with an embodiment of the present disclosure;

FIG. 3 is a block diagram of a computer or a server in accordance with an embodiment of the present disclosure; and

FIG. 4A and FIG. 4B is a flow chart representing the steps involved in a method for speaker verification in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for speaker verification. The system includes a processing subsystem hosted on a server and configured to execute on a network to control bidirectional communications among a plurality of modules. The processing subsystem includes an input receiving module configured to receive an input audio-visual segment from an external source. The processing subsystem also includes an input processing module configured to identify one or more unlabelled speakers from the input audio-visual segment received. The input processing module is configured to identify one or more moments in time associated with each of the one or more unlabelled speakers in the audio-visual segment received using an automated speech recognition technique. The processing subsystem also includes an information extraction module configured to extract audio data representative of speech signal and visual data representative of facial images respectively from the audio-visual segment based on the one or more moments identified. The processing subsystem also includes an input transformation module configured to employ a first pre-trained neural network model to transform extracted audio data representative of speech signal of each unlabelled speaker into a speaker speech space. The input transformation module is also configured to employ a second pre-trained neural network model to transform extracted visual data representative of facial images of each unlabelled speaker into a speaker face space. The input transformation module is also configured to train a third neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively. The processing subsystem also includes a speaker identification module configured to identify the each unlabelled speaker with corresponding names based on a matching result obtained from the third pre-trained neural network model. The speaker identification module is also configured to estimate a confidence level of the third pre-trained neural network model corresponding to identification of the each unlabelled speaker from the audio-visual segment.

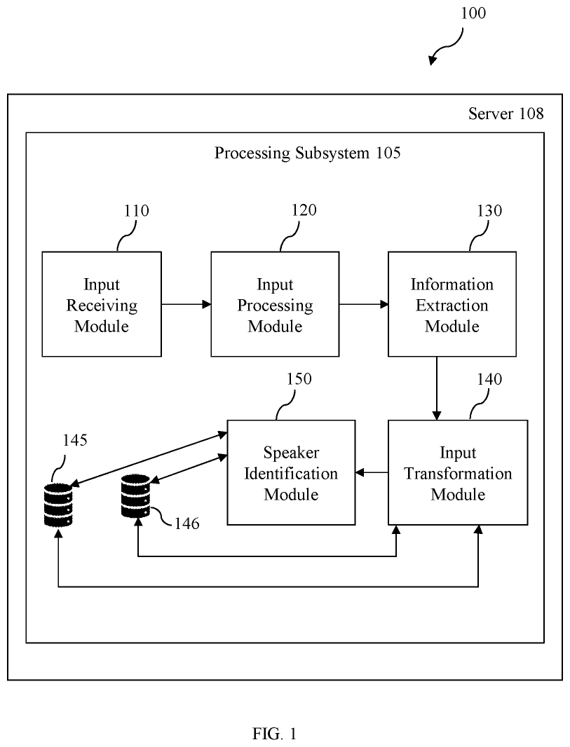

FIG. 1 is a block diagram of a system 100 for speaker verification in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes an input receiving module 110 configured to receive an input audio-visual segment from an external source. In one embodiment, the audio-visual segment may include a plurality of raw clippings of audio data and visual data received. In such embodiment, the audio-visual segment comprises at least one of voice samples of a speaker, a language spoken by the speaker, a phoneme sequence, an emotion of the speaker, an age of the speaker, a gender of the speaker or a combination thereof. In some embodiment, the external source may include, but not limited to, a video, a video conferencing platform, a website, a tutorial portal, an online training platform and the like.

The processing subsystem 105 also includes an input processing module 120 configured to identify one or more unlabelled speakers from the input audio-visual segment received. The input processing module 120 is also configured to identify one or more moments in time associated with each of the one or more unlabelled speakers in the audio-visual segment received using an automated speech recognition technique (ASR). As used herein, the term ‘automated speech recognition technique’ is defined as an interdisciplinary subfield of computer science and computational linguistics that develops methodologies and technologies that enable the recognition and translation of spoken language into text by computers.

The processing subsystem 105 also includes an information extraction module 130 configured to extract audio data representative of speech signal and visual data representative of facial images respectively from the audio-visual segment based on the one or more moments identified.

The processing subsystem 105 also includes an input transformation module 140 configured to employ a first pre-trained neural network model to transform extracted audio data representative of speech signal of each unlabelled speaker into a speaker speech space. In one embodiment, the speaker speech space comprises a new speech space, wherein the audio data from a relevant speaker is plotted closer together whereas the audio data from irrelevant speakers are plotted further apart. The input transformation module 140 is also configured to employ a second pre-trained neural network model to transform extracted visual data representative of facial images of each unlabelled speaker into a speaker face space. In some embodiment, the speaker face space comprises a new face space, wherein faces from the relevant speaker are plotted closer together whereas faces from irrelevant speakers are plotted further apart. The input transformation module 140 is also configured to train a third pre-trained neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively.

In a specific embodiment, the pre-stored audio embedding is retrieved from an audio embedding storage repository 145. In such embodiment, the audio embedding includes a hash representation created of the audio data by a neural network to facilitate speaker identification. In another embodiment, the pre-stored visual embedding is retrieved from a visual embedding storage repository 146. In such embodiment, the visual embedding includes a hash representation created of the image data by a neural network to facilitate speaker identification. In one embodiment, the audio embedding storage repository 145 and the visual embedding storage repository 146 may include a S3™ storage repository. In a particular embodiment, the first pre-trained neural network model, the second pre-trained neural network model and the third neural network model includes implementation of at least a feed forward neural network, multilayer perceptron, convolutional neural network, transformer, graph neural network, a recurrent neural network or a long-short term memory (LSTM).

The processing subsystem 105 also includes a speaker identification module 150 configured to identify the each unlabelled speaker with corresponding names based on a matching result obtained from the third neural network model. The speaker identification module is also configured to estimate a confidence level of the third neural network model corresponding to identification of the each unlabelled speaker from the audio-visual segment. The third neural network model is applied to the input video with unlabelled speakers to predict each of their names. Since some speakers can be new and never before seen, therefore estimates on how confident the model is about the results is obtained. For example, the model can label a speaker as new when the model is not confident. Thus, given a new video with one or more speakers and a prior dataset of labelled speakers, the third neural network can use the audio signal and face images to identify the names of those speakers in the new input video or indicate if any of those speakers are new.

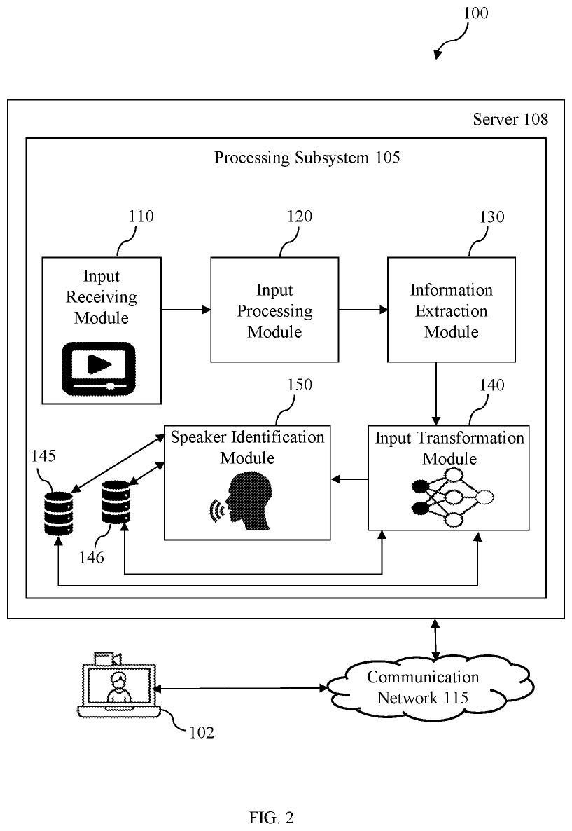

FIG. 2 illustrates a schematic representation of an exemplary embodiment of a system 100 for speaker verification of FIG. 1 in accordance with an embodiment of the present disclosure. Considering an example, where an audio-visual segment of an online video conference is received. In such an example, let us assume that the audio-visual segment includes a raw clipping where conversation of a speaker is captured. Here, the audio-visual segment is received by an input receiving module 110 of the system 100. The input receiving module 110 is hosted on a processing subsystem 105 which is hosted on a cloud server 108. The processing subsystem 105 is configured to execute on a wireless communication network to control bidirectional communications among a plurality of modules.

In order to identify the speaker present in the audio-visual segment, the system 100 processes the input audio-visual segment received by an input processing module 120. The input processing module 120 first identifies one or more unlabelled speakers from the input audio-visual segment received. Also, the input processing module 120 identifies one or more moments in time associated with each of the one or more unlabelled speakers in the audio-visual segment received using an automated speech recognition technique (ASR).

Once, the one or more moments are identified, an information extraction module 130 extracts audio data representative of speech signal and visual data representative of facial images respectively from the audio-visual segment based on the one or more moments identified. Again, an input transformation module 140 employs a first pre-trained neural network model for transformation of extracted audio data representative of speech signal of each unlabelled speaker into a speaker speech space. In the example used herein, the speaker speech space includes a new speech space, wherein the audio data from a relevant speaker or a same speaker is plotted closer together whereas the audio data from irrelevant speakers or different speakers are plotted further apart.

Similarly, the input transformation module 140 is also configured to employ a second pre-trained neural network model to transform extracted visual data representative of facial images of each unlabelled speaker into a speaker face spaces. For example, the speaker face space includes a new face space, wherein faces from the relevant speaker are plotted closer together whereas faces from irrelevant speakers are plotted further apart.

Again, the input transformation module 140 trains a third neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively.

In the example used herein, the pre-stored audio embedding is retrieved from an audio embedding storage repository. In such an example, the audio embedding includes a hash representation created of the audio data by a neural network to facilitate speaker identification. Similarly, the pre-stored visual embedding is retrieved from a visual embedding storage repository. In such an example, the visual embedding includes a hash representation created of the audio data by a neural network to facilitate speaker identification. For example, the audio embedding storage repository and the visual embedding storage repository may include a S3™ storage repository.

Further, the system 100 includes a speaker identification module 150 configured to identify the each unlabelled speaker with corresponding names based on a matching result obtained from the third neural network model. The speaker identification module 150 is also configured to estimate a confidence level of the third neural network model corresponding to identification of the each unlabelled speaker from the audio-visual segment. The third neural network model is applied to the input video with unlabelled speakers to predict each of their names. Since some speakers can be new and never before seen, therefore estimates on how confident the model is about the results is obtained. For example, the model can label a speaker as new when the model is not confident. Thus, given a new video with one or more speakers and a prior dataset of labelled speakers, the third neural network can use the audio signal and face images to identify the names of those speakers in the new input video or indicate if any of these speakers are new.

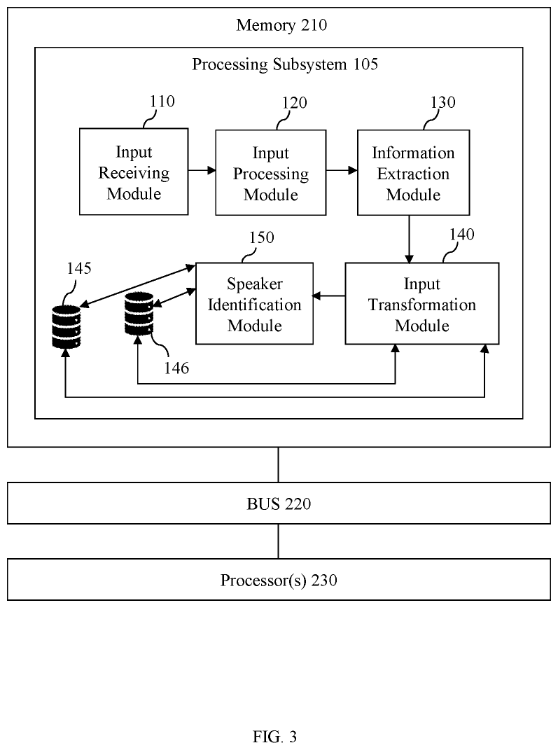

FIG. 3 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: an input receiving module 110, an input processing module 120, an information extraction module 130, an input transformation module 140, an a speaker identification module 150.

The input receiving module 110 configured to receive an input audio-visual segment from an external source. The input processing module 120 configured to identify one or more unlabelled speakers from the input audio-visual segment received. The input processing module 120 is also configured to identify one or more moments in time associated with each of the one or more unlabelled speakers in the audio-visual segment received using an automated speech recognition technique. The information extraction module 130 is configured to extract audio data representative of speech signal and visual data representative of facial images respectively from the audio-visual segment based on the one or more moments identified. The input transformation module 140 is configured to employ a first pre-trained neural network model to transform extracted audio data representative of speech signal of each unlabelled speaker into a speaker speech space. The input transformation module 140 is also configured to employ a second pre-trained neural network model to transform extracted visual data representative of facial images of each unlabelled speaker into a speaker face space. The input transformation module 140 is also configured to train a third neural network model to match the audio data and the visual data of each unlabelled speaker in the corresponding speaker speech space and the speaker face space with names of the labelled speakers obtained from pre-stored datasets, wherein the audio data is compared with pre-stored audio embedding of labelled speakers and the visual data is compared with pre-stored visual embedding of labelled speakers respectively. The speaker identification module 150 is configured to identify the each unlabelled speaker with corresponding names based on a matching result obtained from the third neural network model. The speaker identification module 150 is also configured to estimate a confidence level of the third neural network model corresponding to identification of the each unlabelled speaker from the audio-visual segment.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

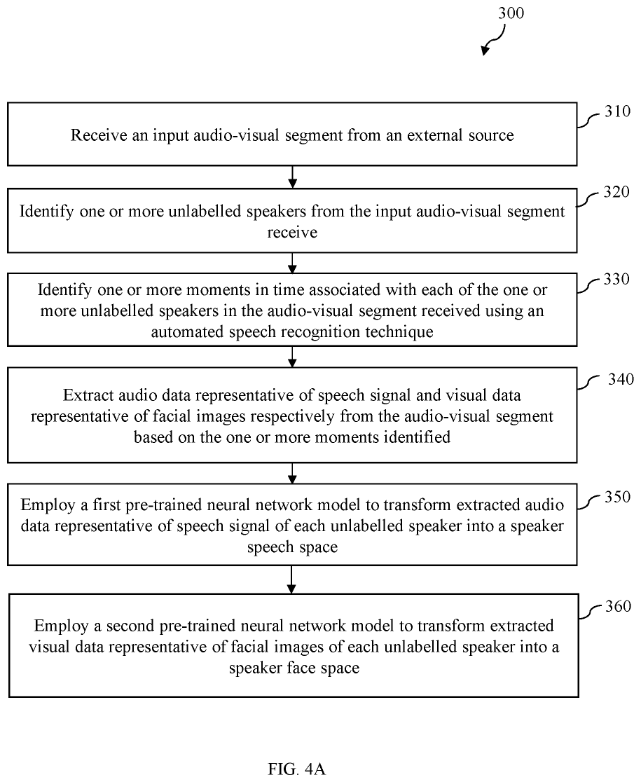

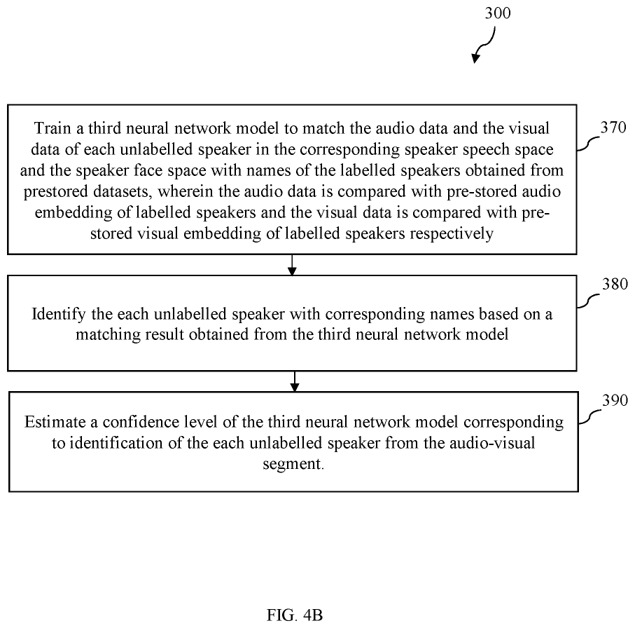

FIG. 4A and FIG. 4B is a flow chart representing the steps involved in a method 300 for speaker verification in accordance with the embodiment of the present disclosure. The method 300 includes receiving, by an input receiving module of a processing subsystem, an input audio-visual segment from an external source in step 310. In one embodiment, receiving the audio-visual segment from the external source may include receiving a plurality of raw clippings of audio data and visual data received. In such embodiment, the audio-visual segment comprises at least one of voice samples of a speaker, a language spoken by the speaker.

The method 300 also includes identifying, by an input processing module of the processing subsystem, one or more unlabelled speakers from the input audio-visual segment received in step 320. The method 300 also includes identifying, by the input processing module of the processing subsystem, one or more moments in time associated with each of the one or more unlabelled speakers in the audio-visual segment received using an automated speech recognition technique in step 330. The method 300 also includes extracting, by an information extraction module of the processing subsystem, audio data representative of speech signal and visual data representative of facial images respectively from the audio-visual segment based on the one or more moments identified in step 340.

The method 300 also includes utilizing, by an input transformation module of the processing subsystem, a first pre-trained neural network model to transform extracted audio data representative of speech signal of each unlabelled speaker into a speaker speech space in step 350. In one embodiment, the speaker speech space comprises a new speech space, wherein the audio data from a relevant speaker is plotted closer together whereas the audio data from irrelevant speakers are plotted further apart.

The method 300 also includes employing, by the input transformation module of the processing subsystem, a second pre-trained neural network model to transform extracted visual data representative of facial images of each unlabelled speaker into a speaker face space in step 360. In some embodiment, the speaker face space comprises a new face space, wherein faces from the relevant speaker are plotted closer together whereas faces from irrelevant speakers are plotted further apart.

The method 300 also includes training, by the input transformation module of the processing subsystem, a third neural network model to match the audio data and the visual data of each unlabelled speaker in the corresponding speaker speech space and the speaker face space with names of the labelled speakers obtained from pre-stored datasets in step 370.

In a specific embodiment, the method also includes retrieving the pre-stored audio embedding from an audio embedding storage repository. In such embodiment, the audio embedding includes a hash representation created of the audio data by a neural network to facilitate speaker identification. In another embodiment, the method also includes retrieving the pre-stored visual embedding is retrieved from a visual embedding storage repository. In such embodiment, the visual embedding includes a hash representation created of the audio data by a neural network to facilitate speaker identification. In one embodiment, the audio embedding storage repository and the visual embedding storage repository may include a S3™ storage repository.

The method 300 also includes identifying, by a speaker identification module of the processing subsystem, the each unlabelled speaker with corresponding names based on a matching result obtained from the third neural network model in step 380. The method 300 also includes estimating, by the speaker identification module of the processing subsystem, a confidence level of the third neural network model corresponding to identification of the each unlabelled speaker from the audio-visual segment in step 390.

Various embodiments of the present disclosure provide a system uses a prior dataset of labelled speakers from audio and video data to identify the names of speakers in an input video.

Moreover, the present disclosed system estimates on how confident the model is about the results. For example, the model can label a speaker as new when the model is not confident. Thus, given a new video with one or more speakers and a prior dataset of labelled speakers, the third neural network can use the audio signal and face images to identify the names of those speakers in the new input video or indicate if any of those speakers are new.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for speaker verification, the system comprising:
a processing subsystem hosted on a server and configured to execute on a network to control bidirectional communications among a plurality of modules comprising:
an input receiving module configured to receive an audio-visual segment from an external source;
an input processing module operatively coupled to the input receiving module, wherein the input processing module is configured to:
identify one or more unlabelled speakers from the audio-visual segment received at the input receiving module; and
identify one or more moments in time associated with each of the one or more unlabelled speakers in the audio-visual segment received at the input receiving module using an automated speech recognition technique;
an information extraction module operatively coupled to the input processing module, wherein the information extraction module is configured to extract audio data representative of a speech signal and visual data representative of facial images respectively from the audio-visual segment based on the one or more moments in time identified by the input processing module;
an input transformation module operatively coupled to the information extraction module, wherein the input transformation module is configured to:
employ a first pre-trained neural network model to transform extracted audio data representative of the speech signal of each unlabelled speaker into a speaker speech space;
employ a second pre-trained neural network model to transform extracted visual data representative of facial images of each unlabelled speaker into a speaker face space; and
train a third neural network model to match the audio data and the visual data of each unlabelled speaker in the speaker speech space and the speaker face space with names of labelled speakers obtained from pre-stored datasets, wherein the audio data is compared with pre-stored audio embedding of labelled speakers and the visual data is compared with pre-stored visual embedding of labelled speakers respectively; and
a speaker identification module operatively coupled to the input transformation module, wherein the speaker identification module is configured to:
identify an unlabelled speaker with a name based on a matching result obtained from the third neural network model; and
estimate a confidence level in the identification of the unlabelled speaker based on the matching result obtained from the third neural network model.

2. The system of claim 1, wherein the audio-visual segment comprises a plurality of raw clippings of audio data and visual data.

3. The system of claim 1, wherein the audio-visual segment comprises at least one of voice samples of a speaker, a language spoken by the speaker, a phoneme sequence, an emotion of the speaker, an age of the speaker, a gender of the speaker or a combination thereof.

4. The system of claim 1, wherein the external source comprises at least one of a video conferencing platform, a website, a tutorial portal, an online training platform or a combination thereof.

5. The system of claim 1, wherein the speaker speech space comprises a new speech space, wherein the audio data from a relevant speaker is plotted closer together and wherein the audio data from an irrelevant speaker is plotted further apart.

6. The system of claim 1, wherein the speaker face space comprises a new face space, wherein visual data from a relevant speaker is plotted closer together and wherein visual data from an irrelevant speaker is plotted further apart.

7. The system of claim 1, wherein the pre-stored audio embedding is retrieved from an audio embedding storage repository.

8. The system of claim 1, wherein the pre-stored visual embedding is retrieved from a visual embedding storage repository.

9. The system of claim 1, wherein the audio embedding comprises a hash representation created from the audio data by a neural network to facilitate speaker identification.

10. The system of claim 1, wherein the visual embedding comprises a hash representation created from the audio data by a neural network to facilitate speaker identification.

11. The system of claim 1, wherein the speaker identification module is configured to provide a percent value representative of the estimation of the confidence level.

12. The system of claim 1, wherein the first neural network model, the second neural network model and the third neural network model comprise implementation of at least a feed forward neural network, a multilayer perceptron, a convolutional neural network, a transformer, a recurrent neural network or a long short-term memory.

13. A method comprising:
receiving, by an input receiving module of a processing subsystem, an audio-visual segment from an external source;
identifying, by an input processing module of the processing subsystem, one or more unlabelled speakers from the audio-visual segment received at the input receiving module;
identifying, by the input processing module of the processing subsystem, one or more moments in time associated with each of the one or more unlabelled speakers in the audio-visual segment received at the input receiving module using an automated speech recognition technique;
extracting, by an information extraction module of the processing subsystem, audio data representative of a speech signal and visual data representative of facial images respectively from the audio-visual segment based on the one or more moments in time identified by the input processing module;
employing, by an input transformation module of the processing subsystem, a first pre-trained neural network model to transform extracted audio data representative of the speech signal of each unlabelled speaker into a speaker speech space;
employing, by the input transformation module of the processing subsystem, a second pre-trained neural network model to transform extracted visual data representative of facial images of each unlabelled speaker into a speaker face space;
training, by the input transformation module of the processing subsystem, a third neural network model to match the audio data and the visual data of each unlabelled speaker in the speaker speech space and the speaker face space with names of labelled speakers obtained from pre-stored datasets, wherein the audio data is compared with pre-stored audio embedding of labelled speakers and the visual data is compared with pre-stored visual embedding of labelled speakers respectively;
identifying, by a speaker identification module of the processing subsystem, an unlabelled speaker with a name based on a matching result obtained from the third neural network model; and
estimating, by the speaker identification module of the processing subsystem, a confidence level in the identification of the unlabelled speaker based on the matching result obtained from the third neural network model.
